(19) United States
(12) Patent Application Publication
(10) Pub. No.: US 2023/0194111 A1
(43) Pub. Date: Jun. 22, 2023

(54) INTAKE/EXHAUST VENT WITH HOOD

(71) Applicant: University of Alaska Fairbanks, Fairbanks, AK (US)

(72) Inventors: TOMAS MARSIK, Fairbanks, AK (US); Riley Bickford, Fairbanks, AK (US)

(21) Appl. No.: 18/145,286

(22) Filed: Dec. 22, 2022

Related U.S. Application Data
(60) Provisional application No. 63/292,790, filed on Dec. 22, 2021.

(51) Int. Cl. F24F 7/06

(52) U.S. Cl. CPC F24F 7/06; F24F 2007/0025

(57) ABSTRACT

An exemplary vent for a heat recovery ventilator is provided. The vent includes an exhaust opening and an intake opening positioned below the exhaust opening. The exhaust opening and the intake opening are configured to be coupled to an air exhaust duct and an air intake duct, respectively, of the heat recovery ventilator. A hood is positioned around the exhaust opening, the hood including a top plate, a first side plate coupled to the top plate, a second side plate coupled to the top plate, and a bottom plate coupled to the first and second side plates. Each of the top plate and the bottom plate is configured to slope downward from the exhaust opening.

### CROSS-REFERENCE TO RELATED APPLICATIONS

This application claims the benefit under 35 U.S.C. § 119(e) to U.S. Provisional Patent Application Ser. No. 63/292,790, filed on Dec. 22, 2021, the entire disclosure of which, including all appendices, is incorporated by reference herein for all purposes.

### GOVERNMENT SUPPORT STATEMENT

This invention was made with government support under N00014-19-1-2235 awarded by the Office of Naval Research. The government has certain rights in the invention.

### BACKGROUND

Heat recovery ventilators (HRVs) and energy recovery ventilators (ERVs) are gaining popularity due to the energy savings that they provide, especially in cold climates. Unlike conventional ventilation options where warm stale air in buildings is directly exhausted to the outside (and thus heat in that air is wasted), HRVs utilize a heat exchanger that recovers the heat from the warm stale air going out and transfers it into the fresh cold air that is coming in. ERVs function in a similar way as HRVs, but also transfer moisture in addition to transferring heat. In this disclosure, the term “HRV” may be used as a substitute for both an HRV and an ERV, as heat recovery ventilation is also one of the functions provided by ERVs.

In order to prevent cross-contamination, the HRV intake opening is typically several feet away from the HRV exhaust opening, which means the installation requires two penetrations through an exterior wall. Some companies are offering a vent with combined intake and exhaust openings, which is a vent that combines the intake and exhaust openings into one wall penetration. This is a practical option as it simplifies the HRV installation. Typically, in order to minimize cross-contamination in such a single wall penetration vent, the exhaust opening of the vent has not had a hood, so that buoyant exhaust air starts moving up and away from the intake opening of the vent as soon as the exhaust air leaves the exhaust opening. However, when used in cold climate conditions, because the exhaust air mixes with the outside air immediately as it leaves the exhaust opening when there is no hood, condensation and ice can develop on a grill (or wire mesh) of the exhaust opening. This ice can eventually block the exhaust opening, freezing it shut and hampering the operation of the HRV.

### SUMMARY

The following description presents a simplified summary of one or more aspects of the systems, devices, and methods described herein. This summary is not an extensive overview of all contemplated aspects and is intended to neither identify key or critical elements of all aspects nor delineate the scope of any or all aspects. Its sole purpose is to present one or more aspects of the systems, devices, and methods.

An exemplary device includes a combined intake/exhaust vent with a hood that largely overcomes the problem of freezing in cold climate conditions. In accordance with embodiments of the present disclosure, a vent combines ventilation intake and exhaust openings into a single wall penetration. The vent further includes a hood positioned around an exterior of the exhaust opening. This vent is particularly useful for use with HRVs and ERVs. This vent may also be referred to as a “dual hood”, a “port”, or a “cap” in some examples.

In accordance with embodiments of the present disclosure, an exemplary vent for a heat recovery ventilator includes an exhaust opening and an intake opening positioned below the exhaust opening. The exhaust opening and the intake opening are configured to be coupled to an air exhaust duct and an air intake duct, respectively, of the heat recovery ventilator. A hood is positioned around the exhaust opening, and the hood includes a top plate, a first side plate coupled to the top plate, a second side plate coupled to the top plate, and a bottom plate coupled to the first and second side plates. Each of the top plate and the bottom plate is configured to slope downward from the exhaust opening toward the intake opening.

In accordance with other embodiments of the present disclosure, an exemplary vent as described herein may include the following elements alone or in combination with one another: the exhaust opening is configured as an air exhaust port having a cross-section shaped as a circular segment; the intake opening is configured as an air intake port having a cross-section shaped as a circular segment; each of the exhaust opening and the intake opening is configured as a port having a cross-section shaped as a circular segment, and the port of the exhaust opening and the port of the intake opening are positioned to have segments of respective circular segments opposed to one another; the top plate is configured to slope downward at an angle A between about 40 and about 80 degrees from vertical; the top plate is configured to slope downward at an angle A between about 50 and about 70 degrees from vertical; the bottom plate is configured to slope downward at an angle B between about 20 and about 70 degrees from vertical; the bottom plate is configured to slope downward at an angle B between about 30 and about 60 degrees from vertical; a front/exterior edge of each of the first side plate and the second side plate are configured to slope away from the top plate at an exterior exhaust hood exit angle C between about 90 and about 140 degrees from the top plate; the first side plate and the second side plate are configured to be positioned parallel to one another; the first side plate and the second side plate are configured to be angled outward at a side plate angle D between about 0 and about 30 degrees from perpendicular to a face of the exhaust opening; a front/exterior edge of the top plate is configured to be positioned above a lowest edge of the exhaust opening; a front/exterior edge of the top plate is configured to be positioned substantially level with a lowest edge of the exhaust opening; a front/exterior edge of the top plate is configured to be positioned below a lowest edge of the exhaust opening; a front/exterior edge of the bottom plate is configured to be positioned above a lowest edge of the intake opening; a front/exterior edge of the bottom plate is configured to be positioned substantially level with a lowest edge of the intake opening; and/or a front/exterior edge of the bottom plate is configured to be positioned below a lowest edge of the intake opening.

In accordance with yet other embodiments of the present disclosure, an exemplary vent as described herein may include the following elements alone or in combination with one another: a front/exterior edge of the hood formed by the top plate, the first and second side plates, and the bottom plate, provide an outline of a geometric shape; the geometric shape includes one of a trapezoid, a square, a rectangle, and an oval segment; the vent including the exhaust opening, the intake opening, and the hood are formed by injection molding; the vent including the exhaust opening, the intake opening, and the hood are formed by 3D printing; the exhaust opening and the intake opening are formed as a single part adaptor and the hood is formed as a separate part; the hood is attached to the adaptor to surround an exterior of the exhaust opening; the adaptor includes a divider dividing the exhaust opening from the intake opening; the adaptor includes a flange for coupling to a wall; the vent further comprises a mesh covering the exhaust opening and the intake opening; and/or the vent further comprises a mesh covering the exhaust opening and the intake opening, and the mesh is positioned between the adaptor and the hood such that the exhaust opening and the intake opening are covered.

In accordance with yet other embodiments of the present disclosure, a heat recovery ventilator may include any of the vents described herein. A method of manufacturing any of the vents or heat recovery ventilators described herein is also disclosed. A method of venting exhaust air from heat recovery ventilators as described herein is also disclosed.

### DESCRIPTION OF THE FIGURES

The accompanying drawings illustrate various embodiments and are a part of the specification. The illustrated embodiments are merely examples and do not limit the scope of the disclosure. Throughout the drawings, identical or similar reference numbers designate identical or similar elements.

FIGS. 1A, 1B, and 1C illustrate perspective views of a vent with dual intake and exhaust openings and an exhaust hood in accordance with embodiments of the present disclosure.

FIGS. 2A, 2B, and 2C illustrate a perspective front view, side view, and bottom view, respectively, of the vent of FIGS. 1A-1C in accordance with embodiments of the present disclosure.

FIGS. 3A, 3B, and 3C illustrate a perspective view, a side view, and a front view of an intake/exhaust vent adaptor in accordance with embodiments of the present disclosure.

FIGS. 4A-4B and 4D-4F illustrate a perspective view, a top view, a back view, a side view, and a front view, respectively, of another vent in accordance with embodiments of the present disclosure, and FIG. 4C illustrates a view of a mesh in accordance with embodiments of the present disclosure.

FIGS. 5A-5G illustrate a perspective view, a front view, a rear view, a side view, another side view, a top view, and a bottom view, respectively, of a vent with dual intake and exhaust openings and an exhaust hood in accordance with embodiments of the present disclosure.

### DESCRIPTION

A vent that includes combined intake and exhaust openings (which may also be referred to as “ports”) with an exhaust hood for HRVs and ERVs is described to advantageously overcome vent freezing in cold climates. In one embodiment, the present disclosure provides a vent that combines the ventilation intake and exhaust openings into a single wall penetration and a hood positioned around an exterior of the exhaust opening. The intake opening is below the exhaust opening, a part of the hood is positioned above the intake opening, and a part of the hood is positioned below the exhaust opening. A part of the hood may also be positioned below the intake opening.

The hood over the exhaust opening provides protection from rain and other elements. Another function that the hood serves on the exhaust opening is that it helps prevent ice from developing that can freeze the exhaust opening. The air being exhausted has more moisture in it than the outside air because of extra moisture added to the exhausted air from indoor sources. Despite the heat recovery, the exhausted air from an HRV is still somewhat warmer than the outside air and thus is more buoyant, and therefore tends to fill the space within a hood before starting to mix with the outside colder air. Because of the moisture in the air being exhausted, condensation and ice can develop when it is mixing with the outside colder air. The hood operates to cause condensation to occur after the exhaust air leaves the vent and ice crystals are carried away by the air stream. A downward-sloped hood traps or caps warm exhaust air while making it more difficult for cold fresh air to enter the interior of the hood.

Advantageously, embodiments of the disclosed vent help to prevent ice from developing on the exhaust opening by creating space within a hood that the exhaust air tends to fill first before mixing with the outside cold air. The hood includes a bottom deflecting plate that is initially positioned above the intake opening but below the exhaust opening. This bottom deflecting plate directs the exhaust air away from both the intake and exhaust openings, thereby preventing significant cross-contamination between the stale exhaust air and fresh intake air. When the exhaust air is past the hood opening, the exhaust air rises away from the intake opening thanks to its buoyancy. Therefore, the intake opening stays exposed to fresh air and cross-contamination from the exhaust air is minimized.

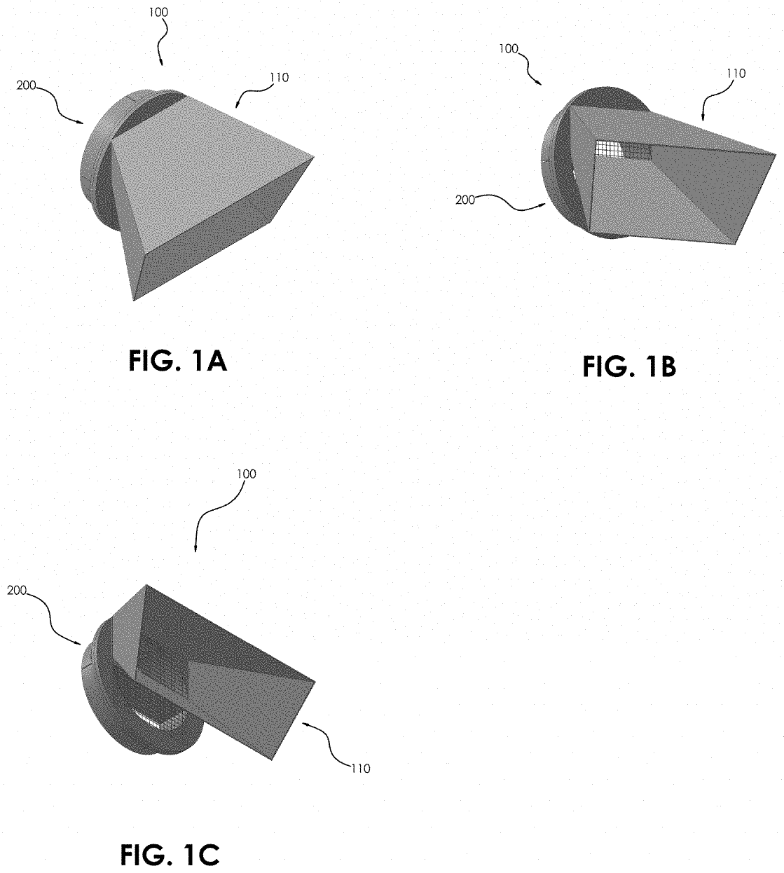

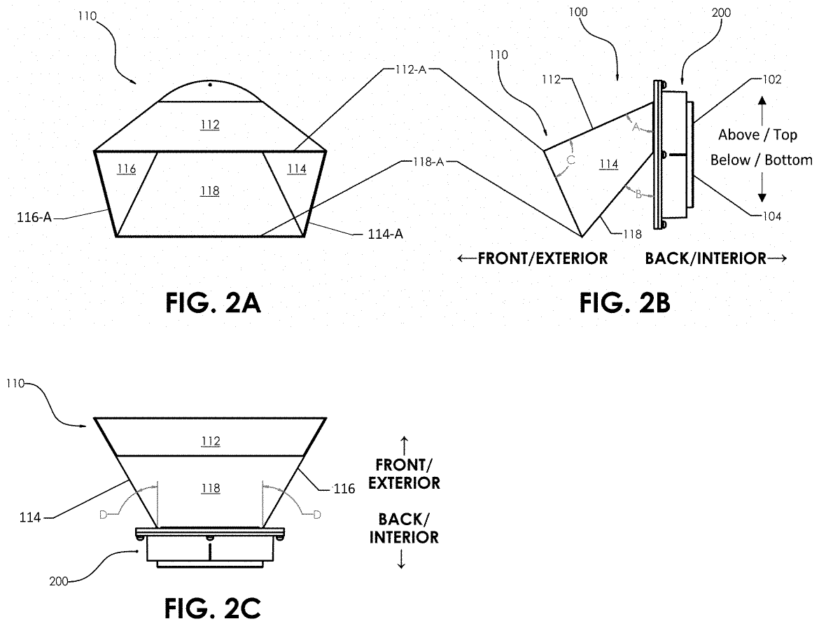

Referring now to FIGS. 1A, 1B, and 1C, perspective views are shown of a vent 100 with a hood 110 about an exhaust opening that is above an intake opening. The exhaust opening and the intake opening may be manufactured as an exhaust opening/intake opening adaptor 200. FIGS. 2A, 2B, and 2C illustrate a front perspective view, side view, and top view, respectively, of the vent 100 of FIGS. 1A-1C in accordance with embodiments of the present disclosure. Adaptor 200 includes an exhaust opening 102 above an intake opening 104, and hood 110 is positioned over an exterior of exhaust opening 102 in accordance with embodiments of the present disclosure.

Hood 110 is formed by a top plate 112, a first side plate 114 coupled to the top plate, a second side plate 116 coupled to top plate 112, and a bottom plate 118 coupled to first and second side plates 114, 116. Each of top plate 112 and bottom plate 118 is configured to slope downward from exhaust opening 102 toward intake opening 104. Bottom plate 118 serves as a deflecting plate to substantially reduce cross-contamination between stale exhaust air exiting exhaust opening 102 and fresh intake air entering intake opening 104. In some aspects, the hood 110 can be formed from sheet metal.

In one example configuration, the length and angle of top plate 112 is such that the lowest part of top plate 112, referred to as a front (or exterior or distal) edge 112-A of top plate 112, is below the lowest part (or edge or bottom) of exhaust opening 102 (for the exhaust air). In another example constraint, front edge 112-A of top plate 112 is substantially level with the lowest part (or edge or bottom) of exhaust opening 102. In yet another example constraint, front edge 112-A of top plate 112 is configured to be positioned above the lowest part (or edge or bottom) of exhaust opening 102. In one example, as illustrated in FIG. 2B, an angle A of top plate 112 relative to vertical is between about 40 and about 80 degrees, and front edge 112-A of top plate 112 is substantially level with or below the lowest part of exhaust opening 102. In another example, angle A of top plate 112 relative to vertical may be between about 50 and about 70 degrees. Other angles of top plate 112 may be possible.

In yet another example configuration, the length and angle from vertical of bottom plate 118 is such that the lowest part of bottom plate 118, referred to as a front (or exterior or distal) edge 118-A of bottom plate 118, is below the lowest part (or edge or bottom) of intake opening 104. In another example constraint, front edge 118-A of bottom plate 118 may be substantially level with or above the lowest part (or edge or bottom) of intake opening 104. In another example, as illustrated in FIG. 2B, an angle B of bottom plate 118 relative to vertical is between about 20 and about 70 degrees, and in yet another example is between about 30 and about 60 degrees, and front edge 118-A of bottom plate 118 is substantially level with or below the lowest part of intake opening 104. An angle B of bottom plate 118 that is too low (i.e., a relatively smaller angle) may not provide sufficient deflection of the exhaust air away from the intake opening. An angle B that is too high (i.e., a relatively larger angle) may decrease the area of the hood opening through which the exhaust air is leaving and can negatively affect the air flow if some ice develops in the area. Other angles of bottom plate 118 may be possible.

In one example, a front edge of hood 110 formed by front edge 112-A of top plate 112, a front edge 114-A of first side plate 114, a front edge 116-A of second side plate 116, and front edge 118-A of bottom plate 118 (FIG. 2A), provide an outline of a geometric shape through which exhaust air is exhausted from hood 110. In one example, the geometric shape may include but is not limited to one of a trapezoid, a square, and a rectangle. In another example, the geometric shape may include a curved or circular geometric shape such as an oval segment. Accordingly, although embodiments herein describe bottom, top, and side plates, it should be understood that the hood 110 can comprise rounded surfaces. Thus, the bottom, top, and side plates need not be planar, although they may. Still further, the top, bottom, and side plates need not be separate elements that intersect at discreet edges. For example, in some aspects, the hood 110 can have rounded cross sections from the vent 100 to the front edge 112. FIG. 2A illustrates an example of a trapezoid geometric shape of the front edge of hood 110. FIG. 2B illustrates an example in which the front edge of hood 110 is not vertical but sloped toward adaptor 200, intake opening 104, or the wall on which vent 100 is mounted.

In one example, vent 100 including exhaust opening 102, intake opening 104, and hood 110 are formed as one piece by injection molding. In another example, vent 100 including exhaust opening 102, intake opening 104, and hood 110 are formed by 3D printing. In yet another example, exhaust opening 102 and intake opening 104 may be formed as a single part adaptor 200 and hood 110 is formed as a separate part. Hood 110, when formed as a separate part, may be attached to adaptor 200 to surround an exterior of exhaust opening 102.

Advantageously, hood 110 creates a pocket of exhaust air, surrounded by top plate 112, side plates 114, 116, and bottom plate 118, that extends below exhaust opening 102. This helps prevent the outside cold air from reaching exhaust opening 102, where mixing and rapid cool down of the exhaust air can result in condensation and ice buildup on the exhaust port.

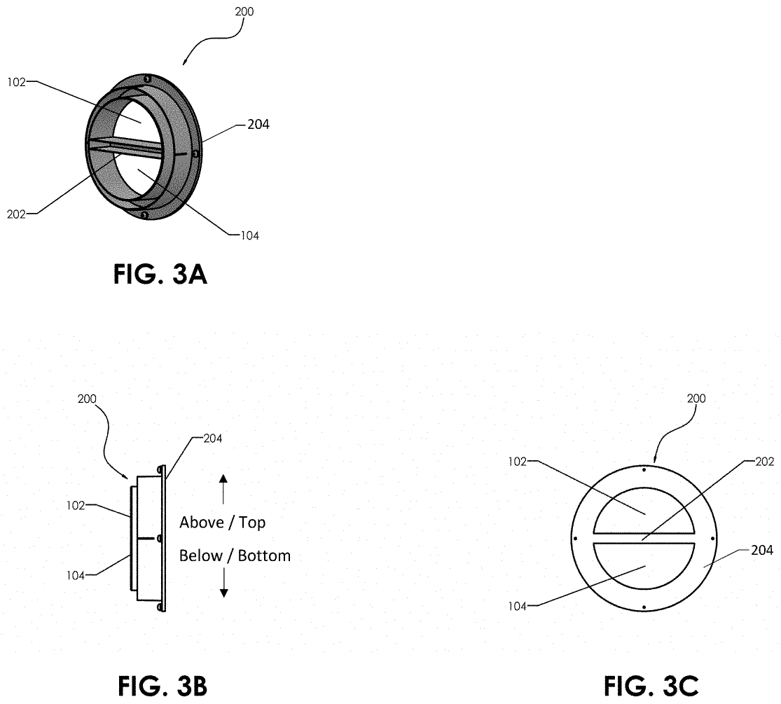

Referring now to FIGS. 3A, 3B, and 3C, a perspective view, a side view, and a front view are respectively shown of intake/exhaust vent adaptor 200 in accordance with embodiments of the present disclosure. Adaptor 200 includes exhaust opening 102 and intake opening 104. Adaptor 200 further includes a divider 202 dividing the exhaust opening from the intake opening. Adaptor 200 may further include a flange 204 for coupling about an exterior wall penetration. Screws, adhesives, and/or the like may be used for coupling flange 204 about an exterior wall penetration.

In one example, exhaust opening 102 is configured as an air exhaust port having a cross-section shaped as a circular segment (FIG. 3C). Intake opening 104 is configured as an air intake port having a cross-section shaped as a circular segment (FIG. 3C). In one exemplary configuration, the port of exhaust opening 102 and the port of intake opening 104 are positioned to have segments of respective circular segments opposed to one another (FIGS. 3A-3C).

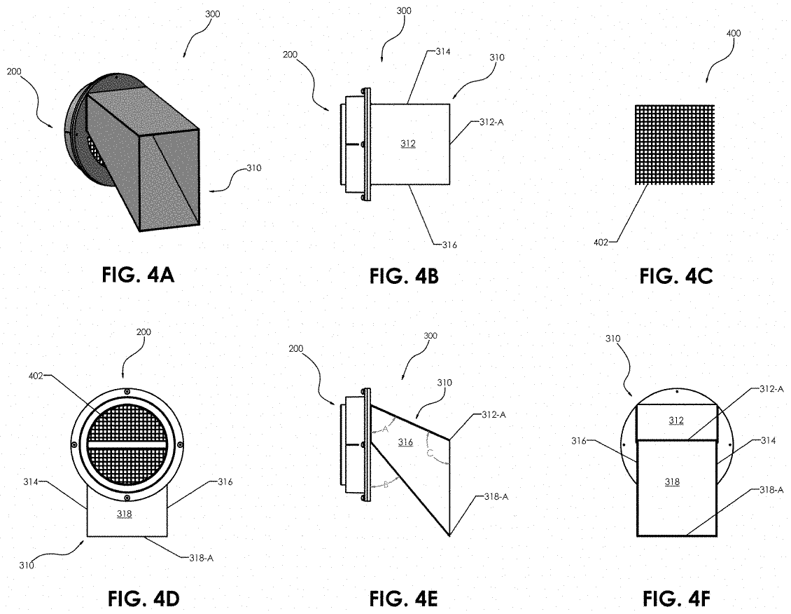

Referring now to FIGS. 4A-4F, FIGS. 4A-4B and 4D-4F illustrate different views of vent 300 in accordance with embodiments of the present disclosure, and FIG. 4C illustrates a view of a mesh 400 in accordance with embodiments of the present disclosure. Vent 300 includes exhaust opening/intake opening adaptor 200 and a hood 310 positioned over an exterior of the exhaust opening of adaptor 200.

Hood 310 is formed by a top plate 312, a first side plate 314 coupled to the top plate, a second side plate 316 coupled to top plate 312, and a bottom plate 318 coupled to first and second side plates 314, 316. Each of top plate 312 and bottom plate 318 is configured to slope downward from an exhaust opening toward the intake opening. Bottom plate 318 again serves as the deflecting plate to substantially reduce cross-contamination between stale exhaust air and fresh intake air.

In one example configuration, the length and angle of top plate 312 is such that the lowest part of top plate 312, referred to as a front (or exterior or distal) edge 312-A of top plate 312, may be positioned below the lowest part (or edge or bottom) of the exhaust opening (for the exhaust air). In another example constraint, front edge 312-A of top plate 312 may be positioned substantially level with the lowest part (or edge or bottom) of the exhaust opening. In yet another example constraint, front edge 312-A of top plate 312 may be configured to be positioned above the lowest part (or edge or bottom) of the exhaust opening. In one example, as illustrated in FIG. 4E, an angle A of top plate 312 relative to vertical is between about 40 and about 80 degrees, and front edge 312-A of top plate 312 is substantially level with or below the lowest part of the exhaust opening.

In yet another example configuration, the length and angle from vertical of bottom plate 318 is such that the lowest part of bottom plate 318, referred to as a front (or exterior or distal) edge 318-A of bottom plate 318, is below the lowest part (or edge or bottom) of the intake opening. In another example constraint, front edge 318-A of bottom plate 318 may be substantially level with the lowest part (or edge or bottom) of the intake opening. In another example, as illustrated in FIG. 4E, an angle B of bottom plate 318 relative to vertical is between about 20 and about 70 degrees, in yet another example is between about 30 and about 60 degrees, and front edge 318-A of bottom plate 318 is below the lowest part of the intake opening. An angle B of bottom plate 318 that is too low (i.e., a relatively smaller angle) may not provide sufficient deflection of the exhaust air away from the intake opening. An angle B that is too high (i.e., a relatively larger angle) may decrease the area of the hood opening through which the exhaust air is leaving and can negatively affect the air flow if some ice develops in the area.

In one example, a front edge of hood 110 formed by front edges of top plate 312, side plates 314, 316, and bottom plate 318 provide an outline of a geometric shape through which exhaust air is exhausted from hood 310. In one example, the geometric shape may include but is not limited to one of a trapezoid, a square, a rectangle, and an oval segment. FIG. 4A illustrates an example of a rectangular geometric shape of the front edge of hood 310. A curved or circular geometric shape is also possible.

FIGS. 4C and 4D illustrate mesh 400 that can prevent objects from entering through the intake or exhaust openings/ports. In one example, mesh 400 is placed between adaptor 200 and hood 310. In another example, mesh 400 may be a wire mesh, and in a particular example may be a 2D grid framework of cylindrical, 0.023 inch diameter galvanized steel wires 402, placed 0.25 inches apart on-center. Other materials, dimensions, orientations, and geometries may be used for mesh 400. A mesh may also be placed between adaptor 200 and hood 110 as described above.

FIG. 4E illustrates an example in which the front edge of hood 310 has a different configuration from that of hood 110 (FIG. 2B) such that the front edges of hood 310 is not sloped toward the adaptor, intake opening, or mounting wall but is vertical or substantially parallel to the face of the exhaust opening/intake opening or mounting wall. It is noted that in other embodiments of a vent hood, the front edges of the hood may be configured so as to slope away from the adaptor, intake opening, or wall.

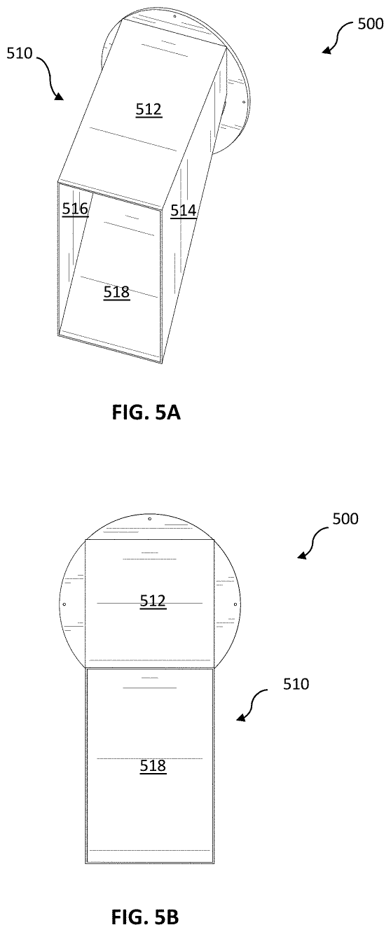

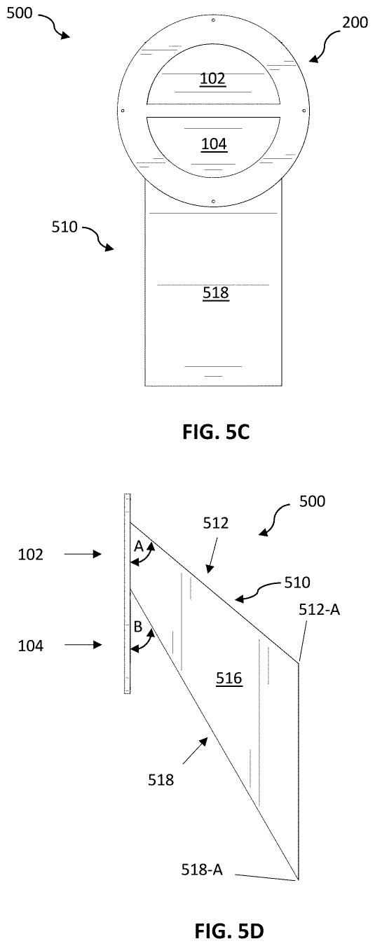

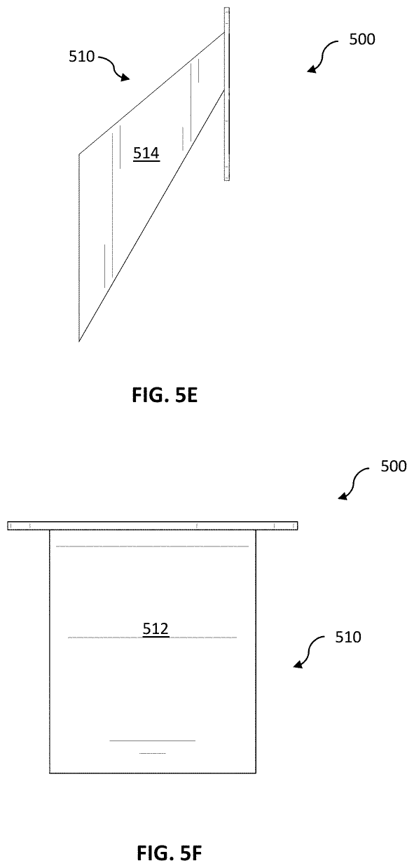

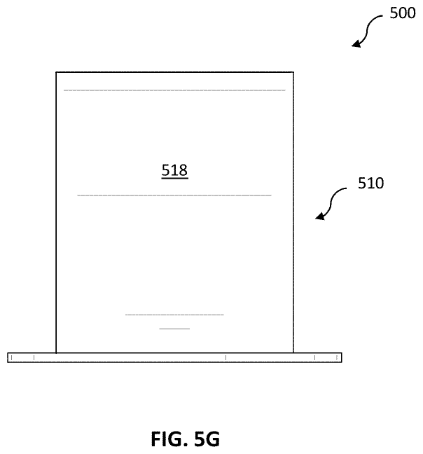

FIGS. 5A-5G illustrate a perspective view, a front view, a rear view, a side view, another side view, a top view, and a bottom view, respectively, of a vent 500 with dual intake and exhaust openings and an exhaust hood 510 in accordance with embodiments of the present disclosure. Hood 510 is formed by a top plate 512, a first side plate 514 coupled to the top plate, a second side plate 516 coupled to top plate 512, and a bottom plate 518 coupled to first and second side plates 514, 516. Each of top plate 512 and bottom plate 518 is configured to slope downward from an exhaust opening 102 toward the intake opening 104. Bottom plate 518 again serves as the deflecting plate to substantially reduce cross-contamination between stale exhaust air and fresh intake air.

In this example, the length and angle of top plate 512 is such that the lowest part of top plate 512, referred to as a front (or exterior or distal) edge 512-A of top plate 512, is positioned below the lowest part (or edge or bottom) of exhaust opening 102, and a front edge 518-A of bottom plate 518 is below the lowest part of intake opening 104. Furthermore, in this example, top plate angle A (relative to vertical) is greater than bottom plate angle B (relative to vertical) (i.e., angle A>angle B).

As used in the preceding disclosure and the claims that follow this disclosure, in some optional aspects, when the term “about” is used in conjunction with a particularly stated angle (e.g., about 40 degrees), it is contemplated that the disclosure encompasses values of the angle that are within 1 degree, within 5 degrees, within 10 degrees, or within 15 degrees of the particularly stated angle (e.g., 39-41 degrees, 35-45 degrees, 30-50 degrees, or 25-55 degrees).

### Heat Model/Calculator Article

“Impact of Intake and Exhaust Ducts on the Recovery Efficiency of Heat Recovery Ventilation Systems”; Marsik, T., Bickford, R.; Dennehy, C.; Garber-Slaght, R.; Kasper, J.; Energies 2021, 14, 351, is incorporated by reference herein for all purposes.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

### Terms

Vent 100, 300, 500
Exhaust opening 102
Intake opening 104
Hood 110, 310, 510
Top plate 112, 312, 512
Front edge of top plate 112-A, 312-A, 512-A
Side plates 114, 116 and 314, 316 and 514, 516
Front edges 114-A and 116-A of side plates 114 and 116
Bottom plate 118, 318, 518
Front edge of bottom plate 118-A, 318-A, 518-A
Top plate angle A
Bottom plate angle B
Exterior exhaust hood exit angle C
Side plate angle D
Exhaust opening/intake opening adaptor 200
Adaptor divider 202
Adaptor flange 204
Mesh 400
Wire 402

1. A vent for a heat recovery ventilator, the vent comprising:
an exhaust opening;
an intake opening positioned below the exhaust opening, wherein the exhaust opening and the intake opening are configured to be coupled to an air exhaust duct and an air intake duct, respectively, of the heat recovery ventilator; and
a hood positioned around the exhaust opening, the hood including:
a top plate;
a first side plate coupled to the top plate;
a second side plate coupled to the top plate; and
a bottom plate coupled to the first and second side plates,
wherein each of the top plate and the bottom plate is configured to slope downward from the exhaust opening.

2. The vent of claim 1, wherein the exhaust opening is configured as an air exhaust port having a cross-section shaped as a circular segment.

3. The vent of claim 1, wherein the intake opening is configured as an air intake port having a cross-section shaped as a circular segment.

4. The vent of claim 1, wherein each of the exhaust opening and the intake opening is configured as a port having a cross-section shaped as a circular segment, and wherein the port of the exhaust opening and the port of the intake opening are positioned to have segments of respective circular segments opposed to one another.

5. The vent of claim 1, wherein the top plate is configured to slope downward at an angle A between about 40 and about 80 degrees from vertical.

6. The vent of claim 1, wherein the top plate is configured to slope downward at an angle A between about 50 and about 70 degrees from vertical.

7. The vent of claim 1, wherein the bottom plate is configured to slope downward at an angle B between about 20 and about 70 degrees from vertical.

8. The vent of claim 1, wherein the bottom plate is configured to slope downward at an angle B between about 30 and about 60 degrees from vertical.

9. The vent of claim 1, wherein a front/exterior edge of each of the first side plate and the second side plate are configured to slope away from the top plate at an exterior exhaust hood exit angle C between about 90 and about 140 degrees from the top plate.

10. The vent of claim 1, wherein the first side plate and the second side plate are configured to be positioned parallel to one another.

11. The vent of claim 1, wherein the first side plate and the second side plate are configured to be angled outward at a side plate angle D between about 0 and about 30 degrees from perpendicular to a face of the exhaust opening.

12. The vent of claim 1, wherein a front/exterior edge of the top plate is configured to be positioned, relative to a lowest edge of the exhaust opening, from one of above the lowest edge of the exhaust opening, substantially level with the lowest edge of the exhaust opening, and below the lowest edge of the exhaust opening.

13. The vent of claim 1, wherein a front/exterior edge of the bottom plate is configured to be positioned, relative to a lowest edge of the intake opening, from one of:
above the lowest edge of the intake opening,
substantially level with the lowest edge of the intake opening, or
below the lowest edge of the intake opening.

14. The vent of claim 1, wherein a front/exterior edge of the hood formed by the top plate, the first and second side plates, and the bottom plate, provide an outline of a geometric shape selected from the group consisting of: a trapezoid, a square, a rectangle, and an oval segment.

15. The vent of claim 1, further comprising a mesh covering the exhaust opening and the intake opening.

16. The vent of claim 1, wherein the exhaust opening and the intake opening are formed as a single part adaptor and the hood is formed as a separate part, wherein the hood is attached to the adaptor to surround an exterior of the exhaust opening, wherein the adaptor includes a divider dividing the exhaust opening from the intake opening, and wherein the adaptor includes a flange for coupling to a wall.

17. The vent of claim 16, further comprising a mesh covering the exhaust opening and the intake opening, and wherein the mesh is positioned between the adaptor and the hood such that the exhaust opening and the intake opening are covered by the mesh.

18. A vent for a heat recovery ventilator, the vent comprising:
an exhaust opening;
an intake opening positioned below the exhaust opening, wherein the exhaust opening and the intake opening are configured to be coupled to an air exhaust duct and an air intake duct, respectively, of the heat recovery ventilator; and
a hood positioned around the exhaust opening, the hood including:
a top plate;
a first side plate coupled to the top plate;
a second side plate coupled to the top plate; and
a bottom plate coupled to the first and second side plates,
wherein the top plate is configured to slope downward at an angle A between about 40 and about 80 degrees from vertical,
wherein the bottom plate is configured to slope downward at an angle B between about 20 and about 70 degrees from vertical,
wherein a front/exterior edge of each of the first side plate and the second side plate are configured to slope away from the top plate at an exterior exhaust hood exit angle C between about 90 and about 140 degrees from the top plate, and
wherein the first side plate and the second side plate are configured to be angled outward at a side plate angle D between about 0 and about 30 degrees from perpendicular to a face of the exhaust opening.

19. A vent for a heat recovery ventilator, the vent comprising:
an exhaust opening;
an intake opening positioned below the exhaust opening, wherein the exhaust opening and the intake opening are configured to be coupled to an air exhaust duct and an air intake duct, respectively, of the heat recovery ventilator; and
a hood positioned around the exhaust opening, the hood including:
a top plate;
a first side plate coupled to the top plate;
a second side plate coupled to the top plate; and
a bottom plate coupled to the first and second side plates,
wherein the top plate and the bottom plate are both configured to slope downward from the exhaust opening,
wherein a front edge of the top plate is configured to be positioned relative to a lowest edge of the exhaust opening at one of below the lowest edge of the exhaust opening and substantially level with the lowest edge of the exhaust opening, and
wherein a front edge of the bottom plate is configured to be positioned below a lowest edge of the intake opening.

20. The vent of claim 19, wherein the top plate is configured to slope downward at an angle A relative to vertical, the bottom plate is configured to slope downward at an angle B relative to vertical, and angle A is greater than angle B.
